(19) United States
(12) Patent Application Publication
(10) Pub. No.: US 2025/0322658 A1
(43) Pub. Date: Oct. 16, 2025

(54) INFORMATION PROCESSING APPARATUS, METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Quan KONG, Tokyo-to (JP); Norimasa KOBORI, Tokyo-to (JP); Rajat SAINI, Tokyo-to (JP); Jingjing PAN, Tokyo-to (JP)

(21) Appl. No.: 19/171,352

(22) Filed: Apr. 7, 2025

(30) Foreign Application Priority Data
Apr. 11, 2024 (JP) 2024-064176

(51) Int. Cl. G06V 20/40; G06F 40/40

(52) U.S. Cl. CPC G06V 20/41; G06V 20/46; G06F 40/40

(57) ABSTRACT

An information processing apparatus includes a controller and the controller is configured to input a video of a first predetermined period to a temporal direction encoder to acquire a first temporal feature amount, extract instance information from the video and input the instance information to a spatial direction encoder to acquire a spatial feature amount, perform, for the first temporal feature amount, a cross-attention operation based on language information of a second predetermined period to acquire a second temporal feature amount, and input the second temporal feature amount and the spatial feature amount to a language processing model to output text information corresponding to the video of the first predetermined period.

### CROSS-REFERENCE TO RELATED APPLICATION

This application claims priority to Japanese Patent Application No. 2024-064176 filed on Apr. 11, 2024, the entire contents of which are incorporated herein by reference.

### TECHNICAL FIELD

The present disclosure relates to an information processing apparatus, a method, and a program for generating text information based on videos.

### BACKGROUND

Prediction technology for generating text information by predicting, based on videos, the contents of the videos is known. For example, Non-patent Literature (NPL) 1 discloses technology for predicting the contents of videos to verbalize them as text information.

### CITATION LIST

### Non-Patent Literature

NPL 1: Muhammad Maaz et al., “Video-ChatGPT: Towards Detailed Video Understanding via Large Vision and Language Models”, arXiv (2023)

### SUMMARY

Conventional technology allows for verbalization in the entire scene (global) or verbalization in any of the instances (local). However, in the conventional technology, the accuracy of the output information is not sufficient. For example, the conventional technology does not allow simultaneous verbalization of the global and local information. Therefore, the conventional technology does not allow accurate verbalization of the position, behavior, gaze, or the like of people, objects, or the like in the videos, or verbalization of these at a fine granularity. In addition, in the conventional technology, it is difficult to accurately verbalize motion changes on the time series and geometrical information. Thus, there is room for improvement with respect to prediction technology based on videos.

It would be helpful to improve prediction technology based on videos.

An information processing apparatus according to an embodiment of the present disclosure includes a controller configured to:
input a video of a first predetermined period to a temporal direction encoder to acquire a first temporal feature amount;
extract instance information from the video and input the instance information to a spatial direction encoder to acquire a spatial feature amount;
perform, for the first temporal feature amount, a cross-attention operation based on language information of a second predetermined period to acquire a second temporal feature amount; and
input the second temporal feature amount and the spatial feature amount to a language processing model to output text information corresponding to the video of the first predetermined period.

A method according to an embodiment of the present disclosure is a method performed by an information processing apparatus, the method including:
inputting a video of a first predetermined period to a temporal direction encoder to acquire a first temporal feature amount;
extracting instance information from the video and inputting the instance information to a spatial direction encoder to acquire a spatial feature amount;
performing, for the first temporal feature amount, a cross-attention operation based on language information of a second predetermined period to acquire a second temporal feature amount; and
inputting the second temporal feature amount and the spatial feature amount to a language processing model to output text information corresponding to the video of the first predetermined period.

A program according to an embodiment of the present disclosure is configured to cause a computer to execute operations, the operations including:
inputting a video of a first predetermined period to a temporal direction encoder to acquire a first temporal feature amount;
extracting instance information from the video and inputting the instance information to a spatial direction encoder to acquire a spatial feature amount;
performing, for the first temporal feature amount, a cross-attention operation based on language information of a second predetermined period to acquire a second temporal feature amount; and
inputting the second temporal feature amount and the spatial feature amount to a language processing model to output text information corresponding to the video of the first predetermined period.

According to an embodiment of the present disclosure, prediction technology based on videos is improved.

### BRIEF DESCRIPTION OF THE DRAWINGS

In the accompanying drawings:

FIG. 1 is a diagram illustrating a schematic configuration of an information processing apparatus according to an embodiment of the present disclosure;

FIG. 2 is a flowchart illustrating operations of the information processing apparatus in a learning process;

FIG. 3 is a schematic diagram of functional blocks of the learning process;

FIG. 4 is a diagram illustrating an overview of processing to extract geometry information from text information; and

FIG. 5 is a flowchart illustrating operations of the information processing apparatus in a prediction process.

### DETAILED DESCRIPTION

Hereinafter, an embodiment of the present disclosure will be described.

### Outline of Embodiment

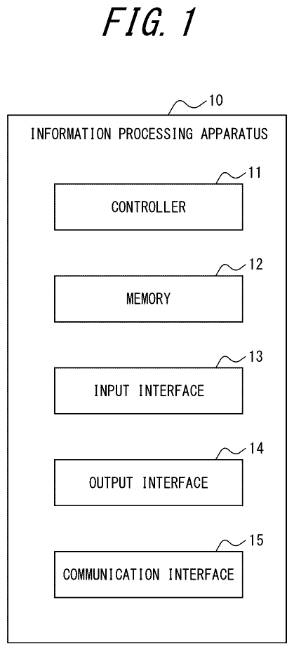

First, an outline of the present embodiment will be described with reference to FIG. 1 An information processing apparatus 10 inputs a video image of the first predetermined period to a temporal direction encoder to acquire the first temporal feature amount. The information processing apparatus 10 also extracts instance information from the video and inputs the instance information to a spatial direction encoder to acquire a spatial feature amount. The information processing apparatus 10 performs, for the first temporal feature amount, a cross-attention operation based on language information of the second predetermined period to acquire the second temporal feature amount. The information processing apparatus 10 then inputs the second temporal feature amount and the spatial feature amount to a language processing model to output text information corresponding to the video of the first predetermined period.

Thus, according to the present embodiment, the temporal direction encoder and the spatial direction encoder are used to acquire a feature amount based on video and instance information, respectively, and the feature amount is used to output text information corresponding to the video using a language processing model. Therefore, prediction technology based on videos is improved in that it can output text information considering both video and instance information, or in other words, it can perform estimation considering the entire video (global) and instance information (local) at the same time.

### (Configuration of Information Processing Apparatus)

Next, a configuration of the information processing apparatus 10 will be described in detail. As illustrated in FIG. 1, the information processing apparatus 10 includes a controller 11, a memory 12, an input interface 13, an output interface 14, and a communication interface 15.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As a connection method, for example, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 includes at least one interface for output. The interface for output is, for example, a display for outputting information in the form of a video, a speaker for outputting information in the form of audio, or the like. The display is, for example, a liquid crystal display (LCD) or an organic electro luminescent (EL) display. The output interface 14 displays and outputs data obtained by the operations of the information processing apparatus 10. The output interface 14 may be connected to the information processing apparatus 10 as an external output device, instead of being included in the information processing apparatus 10. As a connection method, any method such as USB, HDMI®, or Bluetooth® can be used.

The communication interface 15 includes at least one interface for external communication. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth®. The communication interface 15 receives data to be used in the operations of the information processing apparatus 10, and transmits data obtained by the operations of the information processing apparatus 10.

The functions of the information processing apparatus 10 are realized by execution of a program according to the present embodiment by a processor corresponding to the controller 11. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

### (Operations of Information Processing Apparatus)

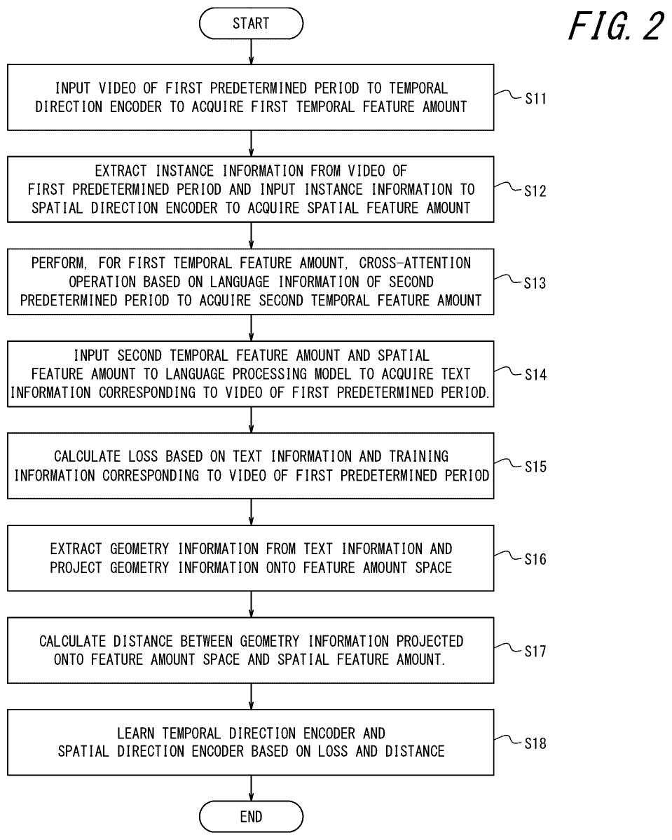

Operations of the information processing apparatus 10 in a learning process according to the present embodiment will be described with reference to FIGS. 2, 3, and 4.

Step S11: The controller 11 of the information processing apparatus 10 inputs the video for learning of the first predetermined period to the temporal direction encoder to acquire the first temporal feature amount. The first predetermined period in the present embodiment is assumed to be the period from t−Δt to t. Δt may be, for example, several seconds. For example, Δt may be 3 seconds.

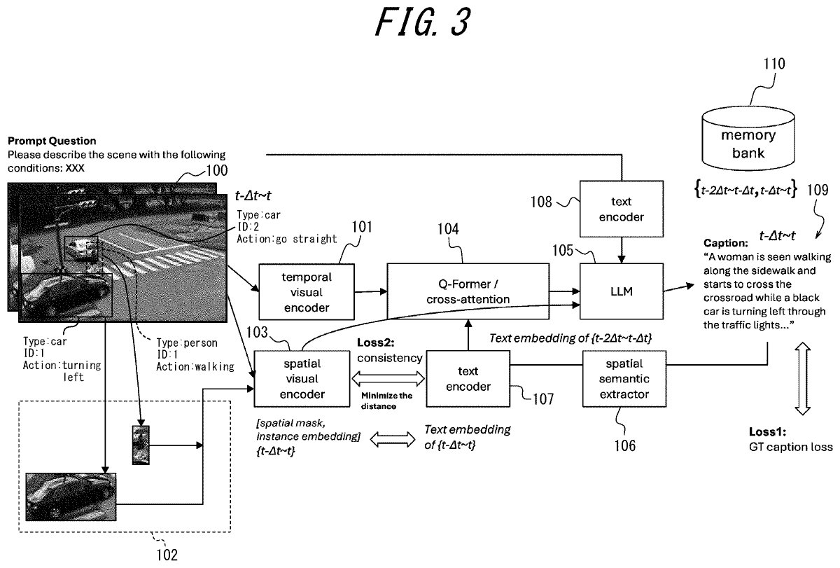

FIG. 3 illustrates a schematic diagram of the functional blocks of the learning process. The functional blocks of the learning process in the present embodiment include a temporal direction encoder 101 (temporal visual encoder), a spatial direction encoder 103 (spatial visual encoder), a cross-attention processor 104 (Q-Former/cross-attention), a language processing model 105 (LLM: Large Language Model), an extractor 106 (Spatial semantic extractor), a text encoder 107 (text encoder), a text encoder 108 (text encoder), and a memory bank 110 (Memory Bank). In the present embodiment, the programs, data, etc. required for these functional blocks are stored in the memory 12, for example, and processing related to these functions is executed by the controller 11 accessing the memory 12.

The controller 11 inputs a video 100 for learning of a period from t−Δt to t to the temporal direction encoder 101. The temporal direction encoder 101 outputs the first temporal feature amount corresponding to that input. Specifically, the temporal direction encoder 101 analyzes the temporal changes between successive image frames of video and encodes data based on these changes to output the first temporal feature amount. The controller 11 acquires the first temporal feature amount.

Step S12: The controller 11 extracts instance information from the video for learning of the first predetermined period and inputs the instance information to the spatial direction encoder to acquire a spatial feature amount. Instance information is information about the object in the video that is the target of verbalization, cropped from the video. Objects include any object. For example, objects include people, vehicles, etc. As illustrated in FIG. 3, the controller 11 extracts the instance information 102 from the video 100 for learning of the period t−Δt to t. Any method can be employed to extract instance information from video. In the FIG. 3 example, the objects to be verbalized are a woman and a black car. In the example in FIG. 3, the number of objects to be verbalized is two, but it is not limited to this; the number of target objects may be one, three or more. The controller 11 inputs said instance information and other necessary information to the spatial direction encoder 103. The information required here is mask information, etc. Mask information is information that indicates the positional relationship of instance information, etc. The controller 11 may, for example, input the video 100 to the spatial direction encoder 103 to obtain mask information. The spatial direction encoder 103 outputs the spatial feature amount corresponding to the input. Specifically, the spatial direction encoder 103 analyzes the spatial information in the image frame and outputs the spatial feature amount. More specifically, the spatial direction encoder 103 outputs the spatial feature amount using similarity of pixel values, patterns, etc. of the input information. The controller 11 acquires the spatial feature amount.

Step S13: The controller 11 performs, for the first temporal feature amount, a cross-attention operation based on the language information of the second predetermined period to acquire the second temporal feature amount. The second predetermined period is the period prior to the first predetermined period. The second predetermined period in the present embodiment is assumed to be the period from t−Δ2t to t−Δt. As illustrated in FIG. 3, the controller 11 inputs the first temporal feature amount output by the temporal direction encoder 101 to the cross-attention processor 104. The cross-attention processor 104 performs, for the first temporal feature amount, a cross-attention operation and outputs the second temporal feature amount. Specifically, the cross-attention processor 104 receives two different data sets (i.e., the first temporal feature amount and the language information of the second predetermined period) as input and performs, for the first temporal feature amount, a cross-attention operation by calculating the degree of influence of the elements of one data set on the elements of the other data set to output the second temporal feature amount. The controller 11 acquires the second temporal feature amount.

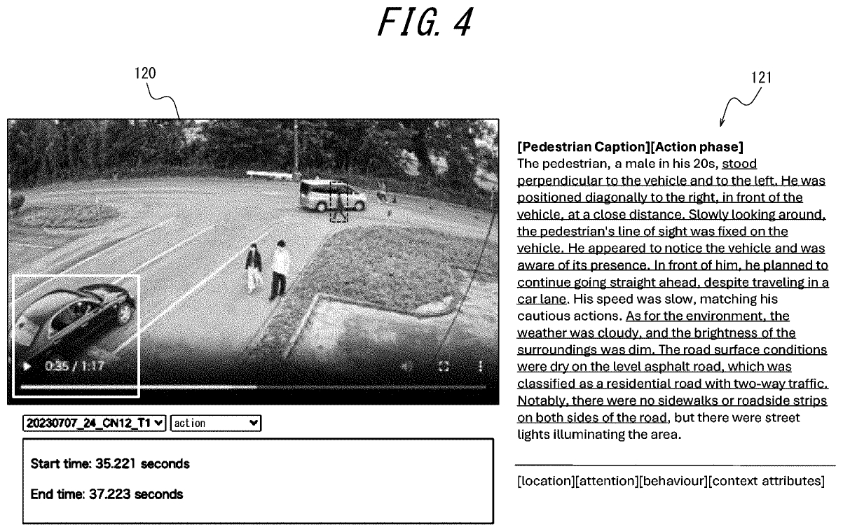

Here, the cross-attention processor 104 performs the cross-attention operation based on the language information of the second predetermined period, as described above. The language information of the second predetermined period is the information generated by the language processing model 105, the extractor 106, and the text encoder 107. The language processing model 105 outputs text information corresponding to the second predetermined period based on the input corresponding to the second predetermined period. The extractor 106 extracts geometry information from the text information corresponding to the second predetermined period. Geometry information is information about the location, orientation, etc. of objects in textual information. FIG. 4 illustrates an overview of the process of extracting geometry information from textual information. The target video in FIG. 4 is a video 120. Text information 121 is information in text format corresponding to a predetermined period of time in this video 120. Specifically, the text information 121 is the information corresponding to the video pertaining to the period from the start time (35.221 seconds) to the end time (37.223 seconds) in the entire duration of the video (1 minute and 17 seconds). The text information 121 includes geometry information, attention information, behavior information, and context information. The extractor 106 extracts geometry information from this information. Specifically, for example, when text information is as follows: “The pedestrian, a male in his 20s, stood perpendicular to the vehicle and to the left. He was positioned diagonally to the right, in front of the vehicle, at a close distance. Slowly looking around, the pedestrian's line of sight was fixed on the vehicle. He appeared to notice the vehicle and was aware of its presence. In front of him, he planned to continue going straight ahead, despite traveling in a car lane. His speed was slow, matching his cautious actions. As for the environment, the weather was cloudy, and the brightness of the surroundings was dim. The road surface conditions were dry on the level asphalt road, which was classified as a residential road with two-way traffic. Notably, there were no sidewalks or roadside strips on both sides of the road, but there were street lights illuminating the area”, the extractor 106 extracts the following part as geometry information: “The pedestrian, a male in his 20s, stood perpendicular to the vehicle and to the left. He was positioned diagonally to the right, in front of the vehicle, at a close distance”.

The text encoder 107 encodes the extracted geometry information to generate language information of the second predetermined period. The cross-attention processor 104 adjusts the weighting based on the language information of the second predetermined period. In other words, the cross-attention processor 104 performs the adjustment of the parameters for the cross-attention operation for the first predetermined period while considering the output for the second predetermined period, which is the previous period.

Step S14: The controller 11 inputs the second temporal feature amount and the spatial feature amount into the language processing model to acquire text information corresponding to the video of the first predetermined period. At this time, the controller 11 also inputs text pertaining to prompt queries for the language processing model, as appropriate.

As illustrated in FIG. 3, the prompt query is, for example, “Please describe the scene with the following conditions: XXX”. The conditions in the prompt query can be set freely. The prompt queries are input to the text encoder 108 and encoded into text in a format that can be input to the language processing model 105. The language processing model 105 outputs text information (Caption) 109 corresponding to the video 100 of the first predetermined period based on the second temporal feature amount and the spatial feature amount corresponding to the first predetermined period and the text of the prompt query. The content of text information 109 is, for example, “A woman is seen walking along the sidewalk and starts to cross the crossroad while a black car is turning left through the traffic lights . . . ”. The controller 11 stores the text information corresponding to each period of video output by the language processing model 105 in the memory bank 110.

Step S15: The controller 11 calculates the loss (Loss1) based on the text information and the training information corresponding to the video of the first predetermined period. Loss1 is also called differential loss. Any method may be used in the calculation process. For example, the controller 11 may calculate the differential loss between the text information corresponding to the video of the first predetermined period and the training information based on a predetermined loss function.

Step S16: The controller 11 extracts geometry information from the text information corresponding to the video image of the first predetermined period and projects it onto the feature amount space. Specifically as illustrated in FIG. 3, the extractor 106 extracts the geometry information corresponding to the first predetermined period from the text information corresponding to the first predetermined period. The text encoder 107 encodes the geometry information corresponding to the first predetermined period and projects it onto the feature amount space. In other words, the text encoder 107 encodes the geometry information corresponding to the first predetermined period into the feature amount corresponding to the information.

Step S17: The controller 11 calculates the distance (Loss2) between the geometry information corresponding to the first predetermined period, which is projected onto the feature amount space, and the spatial feature amount. Loss2 is also referred to as congruency loss. In other words, the controller 11 calculates the distance between the geometry information corresponding to the first predetermined period, which is projected onto the feature amount space, and the spatial feature amount acquired in step S12.

Step S18: The controller 11 learns the temporal direction encoder and the spatial direction encoder based on the loss (Loss1) calculated in step S15 and the distance (Loss2) calculated in step S17. In other words, the controller 11 trains the temporal direction encoder and the spatial direction encoder so that loss and distance are optimized. The loss and distance optimization process can employ any method. For example, the temporal direction encoder and the spatial direction encoder may be learned so that both loss and distance are minimized.

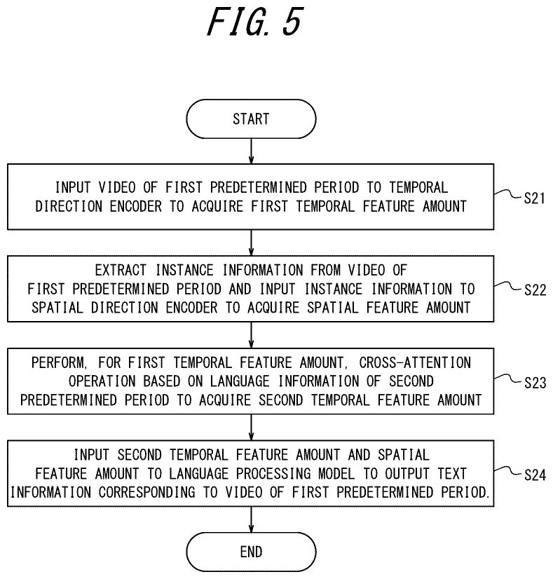

Once the temporal direction encoder and the spatial direction encoder are learned, the information processing apparatus 10 can predict the text information corresponding to the video based on the learned temporal and spatial encoders. Operations of the information processing apparatus 10 in a prediction process according to the present embodiment will be described below with reference to FIG. 5.

Step S21: The controller 11 of the information processing apparatus 10 inputs the video of the first predetermined period to the temporal direction encoder to acquire the first temporal feature amount. Specifically, the controller 11 inputs the video to be predicted for the period t−Δt to t to the learned temporal direction encoder 101. The learned temporal direction encoder 101 outputs the first temporal feature amount corresponding to the input. The controller 11 acquires the first temporal feature amount.

Step S22: The controller 11 extracts instance information from the video of the first predetermined period and inputs the instance information to the learned spatial direction encoder to acquire a spatial feature amount. Specifically, the controller 11 extracts instance information from the video to be predicted for the period t−Δt to t. The controller 11 inputs the instance information, and any other necessary information, to the learned spatial direction encoder 103. The information required here is mask information, etc. The controller 11 may input the video to be predicted, for example, to the learned spatial direction encoder 103 to obtain mask information. The learned spatial direction encoder 103 outputs the spatial feature amount corresponding to the input. The controller 11 acquires the spatial feature amount.

Step S23: The controller 11 performs, for the first temporal feature amount, a cross-attention operation based on the language information of the second predetermined period to acquire the second temporal feature amount. Specifically, the controller 11 inputs the first temporal feature amount output by the learned temporal direction encoder 101 to the cross-attention processor 104. The cross-attention processor 104 performs, for the first temporal feature amount, a cross-attention operation and outputs the second temporal feature amount. The controller 11 acquires the second temporal feature amount.

Step S24: The controller 11 inputs the second temporal feature amount and the spatial feature amount into the language processing model to acquire text information corresponding to the video of the first predetermined period. At this time, the controller 11 also inputs text pertaining to prompt queries for the language processing model, as appropriate. The controller 11 outputs the acquired text information. Any method can be employed to output information. For example, the controller 11 may present information by means of a user interface displayed and output by the output interface 14.

As described above, the information processing apparatus 10 according to the present embodiment uses the temporal direction encoder and the spatial direction encoder to acquire a feature amount based on the video and instance information, respectively, and outputs text information corresponding to the video using a language processing model by using the feature amount.

According to such a configuration, the entire video (global) and instance information (local) can be simultaneously considered for prediction. It is also possible to perform prediction that simultaneously takes into account information related to motion changes on the time series output by the temporal direction encoder and geometrical information output by the spatial directional encoder. Therefore, according to the technology related to the present embodiment, it is possible to output text information that represents, for example, the position, behavior, and line of sight of a person in a video image with high precision and fine granularity. The fine-grained spatio-temporal verbalization technology can be used for verbalization of traffic safety and verbalization of purchasing behavior and the behavior of workers in factories, etc., and can also be used to conduct further detailed analysis. Thus, according to the present embodiment, prediction technology based on videos is improved.

According to the present embodiment, the controller 11 also performs, for the first temporal feature amount, a cross-attention operation based on the language information of the second predetermined period. In other words, the cross-attention operation is performed for the first predetermined period while taking into account the output of the previous period, the second predetermined period. Since the output information of the previous time is taken into account and the output to the current time is adjusted in this manner, the continuity on the time series of the output content can be ensured according to the present embodiment.

In the present embodiment, the first predetermined period is assumed to be the period from t−Δt to t. The second predetermined period is assumed to be the period from t−Δ2t to t−Δt. Thus, the time widths (Δt) of the first predetermined period and the second predetermined period are same. Furthermore, the first predetermined period is the period immediately following the second predetermined period. In this way, the certainty of guaranteeing the continuity on the time series of the output content can be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, in step S17, the controller 11 calculates the distance between the geometry information corresponding to the first predetermined period, which is projected onto the feature amount space, and the spatial feature amount acquired in step S12. In other words, in step S17, the controller 11 calculates the distance between the geometry information and spatial feature amount corresponding to the video of the same period, but this is not limited to this. In other words, the time period of the information for which the distance is calculated in step S17 does not have to be the same. For example, the controller 11 may calculate the distance between the geometry information corresponding to the second predetermined period, which is projected onto the feature amount space, and the spatial feature amount acquired in step S17. In this case, the controller 11 may learn the temporal direction encoder and the spatial direction encoder in step S18 based on the distance and the loss calculated by step S15. Alternatively, the controller 11 may calculate both the distance between the geometry information corresponding to the first predetermined period, which is projected onto the feature amount space, and the spatial feature amount acquired in step S17, and the distance between the geometry information corresponding to the second predetermined period, which is projected onto the feature amount space, and the spatial feature amount acquired in step S17. In this case, the controller 11 may learn the temporal direction encoder and the spatial direction encoder in step S18 based on these two distances and the loss calculated by step S15. In this way, the distance over the previous period, the second predetermined period, can also be reflected in the learning process of the temporal direction encoder and the spatial direction encoder to optimize the distance.

For example, in the present embodiment above, we have described an example in which the prediction process is performed using the temporal direction encoder and the spatial direction encoder learned by the method of steps S11 to S18, but the method of learning the temporal direction encoder and the spatial direction encoder is not limited to the method of steps S11 to S18. The information processing apparatus 10 may perform the prediction process for steps S21 to S22 using the temporal direction encoder and the spatial direction encoder learned by any method.

For example, an embodiment in which the configuration and operations of the information processing apparatus 10 in the above embodiment are distributed to multiple other computers capable of communicating with each other can be implemented. In other words, the functional blocks for the temporal direction encoder 101, the spatial direction encoder 103, the cross-attention processor 104, the language processing model 105, the extractor 106, the text encoder 107, the text encoder 108, and the memory bank 110 described above may be distributed among the information processing apparatus 10 and multiple other apparatuses as appropriate.

1. An information processing apparatus comprising a controller configured to:
input a video of a first predetermined period to a temporal direction encoder to acquire a first temporal feature amount;
extract instance information from the video and input the instance information to a spatial direction encoder to acquire a spatial feature amount;
perform, for the first temporal feature amount, a cross-attention operation based on language information of a second predetermined period to acquire a second temporal feature amount; and
input the second temporal feature amount and the spatial feature amount to a language processing model to output text information corresponding to the video of the first predetermined period.

2. The information processing apparatus according to claim 1, wherein the temporal direction encoder and the spatial direction encoder are learned based on a distance between geometry information and the spatial feature amount, and a loss based on the text information and training information, the training information corresponding to the video in the first predetermined period and the geometry information being extracted from the text information and projected onto a feature amount space.

3. The information processing apparatus according to claim 1, wherein time widths of the first predetermined period and the second predetermined period are same, and the first predetermined period is a period immediately following the second predetermined period.

4. A method performed by an information processing apparatus, the method comprising:
inputting a video of a first predetermined period to a temporal direction encoder to acquire a first temporal feature amount;
extracting instance information from the video and inputting the instance information to a spatial direction encoder to acquire a spatial feature amount;
performing, for the first temporal feature amount, a cross-attention operation based on language information of a second predetermined period to acquire a second temporal feature amount; and
inputting the second temporal feature amount and the spatial feature amount to a language processing model to output text information corresponding to the video of the first predetermined period.

5. A non-transitory computer readable medium storing a program configured to cause a computer to execute operations, the operations comprising:
inputting a video of a first predetermined period to a temporal direction encoder to acquire a first temporal feature amount;
extracting instance information from the video and inputting the instance information to a spatial direction encoder to acquire a spatial feature amount;
performing, for the first temporal feature amount, a cross-attention operation based on language information of a second predetermined period to acquire a second temporal feature amount; and
inputting the second temporal feature amount and the spatial feature amount to a language processing model to output text information corresponding to the video of the first predetermined period.
